(19) United States
(12) Patent Application Publication
(10) Pub. No.: US 2004/0088335 A1
(43) Pub. Date: May 6, 2004

(54) Method and system for ghosting a property during synchronization

(75) Inventors: Jon Changzheng Xu, Bellevue, WA (US); Razvan Mathias, Woodinville, WA (US); Selva Nalliah, Redmond, WA (US); Zhidong Yang, Bellevue, WA (US); Gary William Hall, Redmond, WA (US)

Correspondence Address: MERCHANT & GOULD, P.O. BOX 2903, MINNEAPOLIS, MN, 55402-0903, US

(73) Assignee: Microsoft Corporation, Redmond, WA

(21) Appl. No.: 10/422,869

(22) Filed: Apr. 23, 2003

Related U.S. Application Data
(60) Provisional application No. 60/423,884, filed on Nov. 5, 2002.

(51) Int. Cl. G06F 12/00

(52) U.S. Cl. 707/204

(57) ABSTRACT

An apparatus and method are directed to maintaining fidelity of a data property during data synchronization. A data property may include virtually any attribute that characterizes an aspect of an application's data. An application may include an email application, contact, calendar, scheduling application, and the like. Data properties may also characterize aspects of a non-application, such as a client's hardware device. Data fidelity is maintained through a concept called herein as property ghosting. Property ghosting leaves selected data properties unchanged on a server when the client device does not send the data property back to the server during data synchronization.

### CROSS REFERENCE TO RELATED APPLICATIONS

This application claims the benefit of U.S. Provisional Application Ser. No. 60/423,884, filed Nov. 5, 2002, the benefit of the earlier filing date of which is hereby claimed under 35 U.S.C. § 119 (e).

### FIELD OF THE INVENTION

The present invention relates generally to computer-executable software, and more particularly to maintaining data fidelity during synchronization.

### BACKGROUND OF THE INVENTION

In today's society, portable computing devices are becoming increasingly more common. A portable computing device, such as a laptop, personal digital assistant, and the like, is often used in conjunction with a desktop computer, a server, or the like. For example, a user of the portable computing device may have access to, and use, the desktop computer from home, work, or both. The user may typically run the same types of applications on both the desktop computer and on the portable computing device. Thus, it is quite advantageous for such portable computing devices to be coupled to the desktop computer, to exchange and share information with, the desktop computer, or server. In such a configuration, the portable computing device may sometimes be called a client.

Moreover, the user may also make changes to the portable computing device, and information associated with an application on both the portable computing device and the desktop computer. Therefore, it is advantageous for information and applications on both the portable computing device and desktop computer or server to contain the most up-to-date information, regardless of which device the change may have originated. The process of coupling the portable computing device with the desktop computer or server, and integrating the information stored by the devices such that the devices contain substantially the same updated information is referred to as synchronization.

A number of problems may arise, however, when attempting to synchronize information across functionally different computing systems. For example, suppose that the portable computing device is constrained, for a variety of reasons, to supporting only a subset of an application or its related properties that are also accessed by the desktop computer. Then, during a synchronization of information associated with the application, the desktop computer or server may receive only a portion of the information it expects to receive. In such situations, this may result in lose of potentially valuable information. Therefore, it is with respect to these considerations and others that the present invention has been made.

### SUMMARY OF THE INVENTION

The present invention is directed to addressing the above-mentioned shortcomings, disadvantages and problems, and will be understood by reading and studying the following specification. A method and apparatus are directed to maintaining fidelity of a data property during data synchronization. The data property may include virtually any attribute that characterizes an aspect of an application's data. A data property may also characterize an aspect of a non-application, such as a client's hardware device. Data fidelity is maintained by property ghosting, which leaves a selected data property unchanged on a server if the client device does not send the data property back to the server during data synchronization.

In one aspect of the present invention, a computer-readable medium having computer executable instructions is directed to maintaining data fidelity during synchronization. The computer executable instructions determine a supported property associated with a client. A second set of properties is received in response to sending a first set of properties to the client during the synchronization. If the two sets of properties differ by a property, and the property is associated with the supported property, the property is deleted. If the two sets of properties differ by the property, and the property is unassociated with the supported property, the property is left unchanged.

In another aspect of the invention, a computer-readable medium having computer executable components is directed to maintaining data fidelity during synchronization. The computer executable components include a data store and a ghost synchronizer. The data store includes at least one data property. The ghost synchronizer is configured to receive a request to synchronize at least one data property with a client. The ghost synchronizer determines a supported property associated with the client, and sends a first set of properties to the client during the synchronization. In response, the ghost synchronizer receives a second set of properties from the client. If the first set of properties differs from the second set of properties by a property, and the property is the supported property, the property is deleted. If the first set of properties differs from the second set of properties by the property, and the property is an unsupported property, the property is left unchanged.

In still another aspect of the invention, an apparatus is directed to maintaining data fidelity during synchronization. The apparatus includes a transceiver and a transcoder. The transceiver is configured to send a first set properties to a client and to receive a second set of properties from the client. The transcoder is configured to receive information identifying a supported property associated with the client, and to send the first set of properties to the client during the synchronization. The transcoder further receives in response, the second set of properties from the client. If the first set of properties differs from the second set of properties by a property, and the property is identified as the supported property, the property is deleted. If the first set of properties differs from the second set of properties by the property, and the property is identified as an unsupported property, the property is left unchanged.

### BRIEF DESCRIPTION OF THE DRAWINGS

The foregoing aspects and many of the attendant advantages of the present invention will become more readily appreciated as the same becomes better understood by reference to the following detailed description, when taken in conjunction with the accompanying drawings, wherein:

FIG. 1 shows a functional block diagram illustrating an exemplary environment for practicing the invention;

FIG. 2 shows an exemplary server that may be included in a system implementing the invention;

FIG. 3 shows a functional block diagram of server components employing a synchronization manager for ghosting a property; and

FIG. 4 illustrates a logical flow diagram generally showing one embodiment for ghosting a data property during synchronization, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments through which the present invention may be practiced. The present invention may, however, be embodied in many different forms and should not be construed as limited to the embodiments set forth herein; rather, these embodiments are provided so that this disclosure will be thorough and complete, and will fully convey the scope of the present invention to those skilled in the art. Like numbers refer to like elements throughout. As will be appreciated by one of skill in the art, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise.

The term “connected” means a direct connection between the things that are connected, without any intermediary devices or components.

The term “coupled,” means a direct connection between the things that are connected, or an indirect connection through one or more either passive or active intermediary devices or components.

The terms “comprising,” “including,” “containing,” “having,” and “characterized by,” mean an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

Briefly stated, the present invention is directed towards providing a system and method for maintaining fidelity of a data property during synchronization. A data property may include virtually any attribute, feature, or the like, that characterizes an aspect of an application's data. An application may include an email application, contact, calendar, scheduling application, and the like. An example of an email data property includes whether an email message was read. Data properties may also characterize aspects of a non-application, such as a client's hardware device. The present invention enables data fidelity by employing a concept called herein as property ghosting. Property ghosting includes the systems and methods where selected data associated with a property for the client's device, application, and the like, is left unchanged on a server when the client device does not send the data property back to the server during synchronization.

### Illustrative Operating Environment

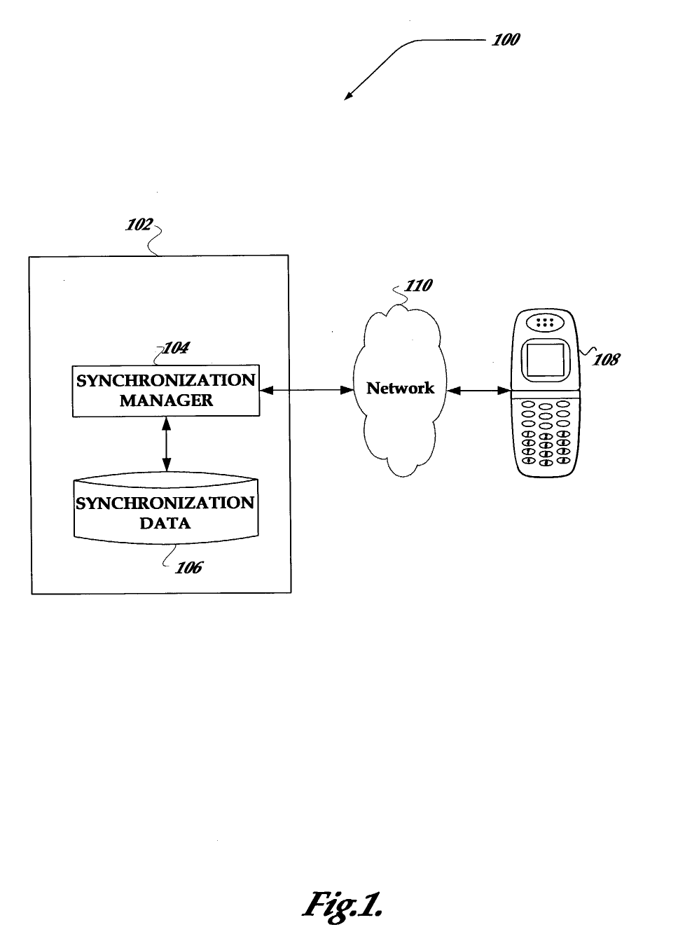

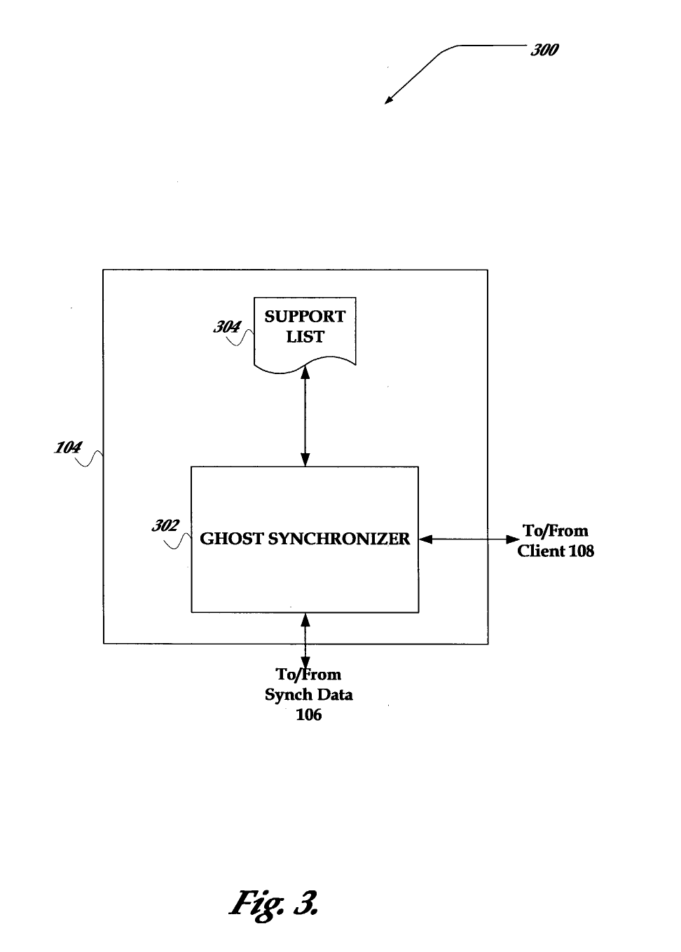

FIG. 1 shows a functional block diagram illustrating an exemplary environment for practicing the present invention, according to one embodiment of the invention. The environment includes server 102, network 110, and client 108. Network 110 is in communication with server 102 and client 108. Server 102 includes synchronization manager 104 and synchronization data 106, which are described in more detail in conjunction with FIG. 3.

Generally, client 108 may include virtually any portable computing device capable of connecting to another computing device and synchronizing information. Such devices include cellular telephones, smart phones, display pagers, radio frequency (RF) devices, infrared (IR) devices, integrated devices combining one or more of the preceding devices, and the like. Client 108 may also include other devices, such as Personal Digital Assistants (PDAs), handheld computers, tablet computers, personal computers, multiprocessor systems, microprocessor-based or programmable consumer electronics, network PCs, wearable computers, and the like. As such, client devices typically range widely in terms of capabilities and features. For example, a cell phone may have a numeric keypad and a few lines of monochrome LCD display on which only text may be displayed. A web-enabled client device may have a touch sensitive screen, a stylus, and several lines of color LCD display in which both text and graphics may be displayed. A client computer may have a keyboard, mouse, speakers, microphone, and a relatively large area on which to display forms. Client 108 further includes low-end devices that may have limited storage memory, reduced application sets, low bandwidth for transmission of a communication, or the like. Such low-end devices may be constrained, for a variety of reasons, to managing a sub-set of data properties related to an application or hardware configuration.

Network 110 couples server 102 and its components with client 108. The network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 110 includes any communication method by which information may travel between client 108 and synchronization manager 104 on server 102.

Server 102 is described in more detail below in conjunction with FIG. 3. Briefly, however, Server 102 may include any computing device capable of connecting to client 108, to store, retrieve, and execute synchronization manager 104 in response to synchronize requests from client 108 through network 110. Such devices include personal computers desktop computers, multiprocessor systems, microprocessor-based or programmable consumer electronics, network PCs, servers, and the like.

Synchronization manager 104 is described in more detail in conjunction with FIG. 3. Briefly, however, synchronization manager 104 is configured to interact with a corresponding synchronization manager, or application, on client 108 to keep information, such as synchronization data 106, and the like, synchronized with corresponding information stored on client 108.

Synchronization manager 104 may be deployed as a transcoder that comprises logic circuitry or software executing on an electronic device, such as a processor, within server 102, or it may execute or reside elsewhere. Synchronization manager 104 operating as a transcoder may access connection data, or other information to determine an action to perform upon receipt of information from client 108, or it may be “hard-wired” to perform a certain action depending upon other pre-defined conditions, including directions to synchronize data.

### Illustrative Server Environment

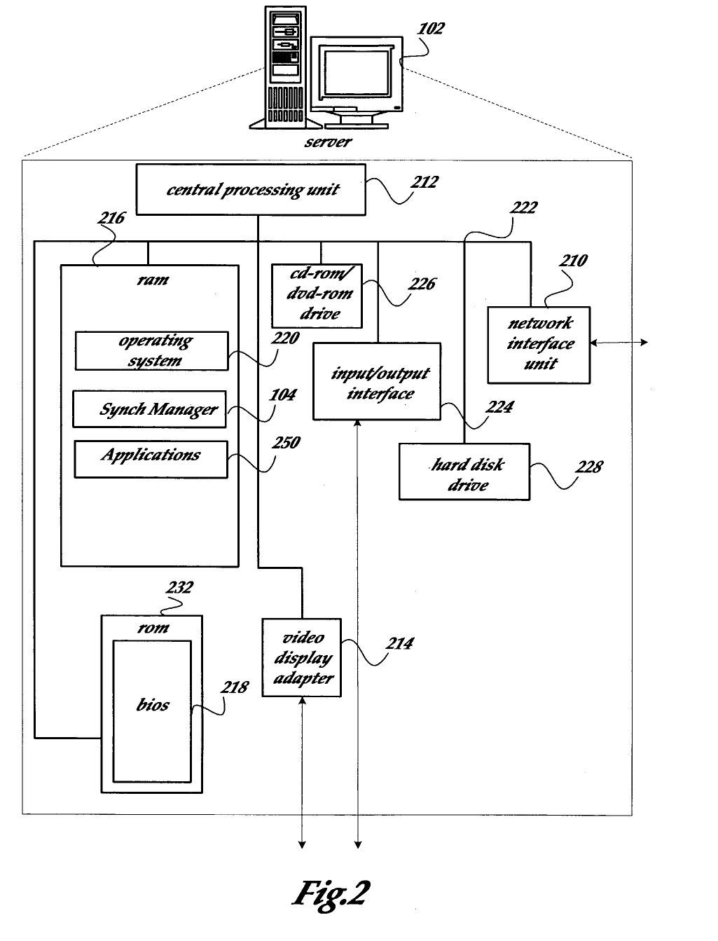

FIG. 2 shows an exemplary server 102 that may be included in a system implementing the invention, according to one embodiment of the invention. Server 102 may include many more components than those shown. The components shown, however, are sufficient to disclose an illustrative embodiment for practicing the invention.

Server 102 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server 102. Any general-purpose operating system may be employed. Basic input/output system (“BIOS”) 218 is also provided for controlling the low-level operation of server 102. As illustrated in FIG. 2, server 102 also can communicate with the Internet, or some other communications network, such as network 104 in FIG. 1, via network interface unit 210, which is constructed for use with various communication protocols including the TCP/IP protocol. Network interface unit 210 is sometimes known as a transceiver or transceiving device.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for ghosting a data property during synchronization. One or more applications 250 are loaded into mass memory and run on operating system 220. Examples of application programs include email programs, schedulers, calendars, contact database programs, word processing programs, spreadsheet programs, and so forth. Applications 250 may also use and store information such as e-mail, synchronization data 106, contact information, databases, and the like, used by synchronization manager 104, appointment information used by a scheduling program, and the like.

Server 102 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Server 102 also includes input/output interface 224 for communicating with external devices, such as a mouse, keyboard, scanner, or other input devices not shown in FIG. 2. Likewise, server 102 may further include additional mass storage facilities such as CD-ROM/DVD-ROM drive 226 and hard disk drive 228. Hard disk drive 228 is utilized by server 102 to store, among other things, application programs, databases, synchronization data 106, and the like.

FIG. 3 is a functional block diagram of server 102, illustrating in greater detail certain server components employing a synchronization manager for ghosting a property, according to one embodiment of the invention. Synchronization manager 104 may include many more components that shown in FIG. 3. The components shown, however, are sufficient to disclose an illustrative embodiment for practicing the invention.

As shown in the figure, synchronization manager 104 includes support list 304, and ghost synchronizer 302.

Support list 304 is configured to provide storage of data properties, and the like, supported by a client device, such as client 108 in FIG. 1. Support list 304 may include a database, a flat file, a directory structure, and the like. The supported data properties may be stored in a directory structure based on an associated application, application type, or the like. For example, support data properties may be associated with a client's email, contact, calendar application, or the like.

Supported data properties for the contact application may include whether a contact phone number, a name, an email address associated with the contact, and the like, are in a contact database. Supported data properties for the email may include whether an email message has been read. Supported data properties for the calendar application may include when an item begins, when the item ends, a time zone, a subject, a body, and the like. Supported data properties may include virtually any information that distinguishes a data property supported on one client device from another data property. Support data properties, for example, may include information associated with hardware features of the client device, without departing from the scope or spirit of the present invention.

Ghost synchronizer 302 is configured to maintain data fidelity during synchronization of information between client 108 and server 102 in FIG. 1. More particularly, ghost synchronizer 302 is configured to receive information from client 108 and determine whether a particular data property is to be ghosted (for example, left unchanged) on server 102. Ghost synchronizer 302 may receive information associated with data properties that are supported by the client device, and store such information in support list 304. Ghost synchronizer 302 is further configured to employ information in support list 304 to ignore missing data properties returned from the client device during synchronization. Because ghost synchronizer 302 is enabled to ghost missing data properties from the client device, the present invention may provide increased flexibility for server 102 to service multiple client device types with multiple data property sets while minimizing the use of a property level change tracking mechanism.

### Generalized Operation

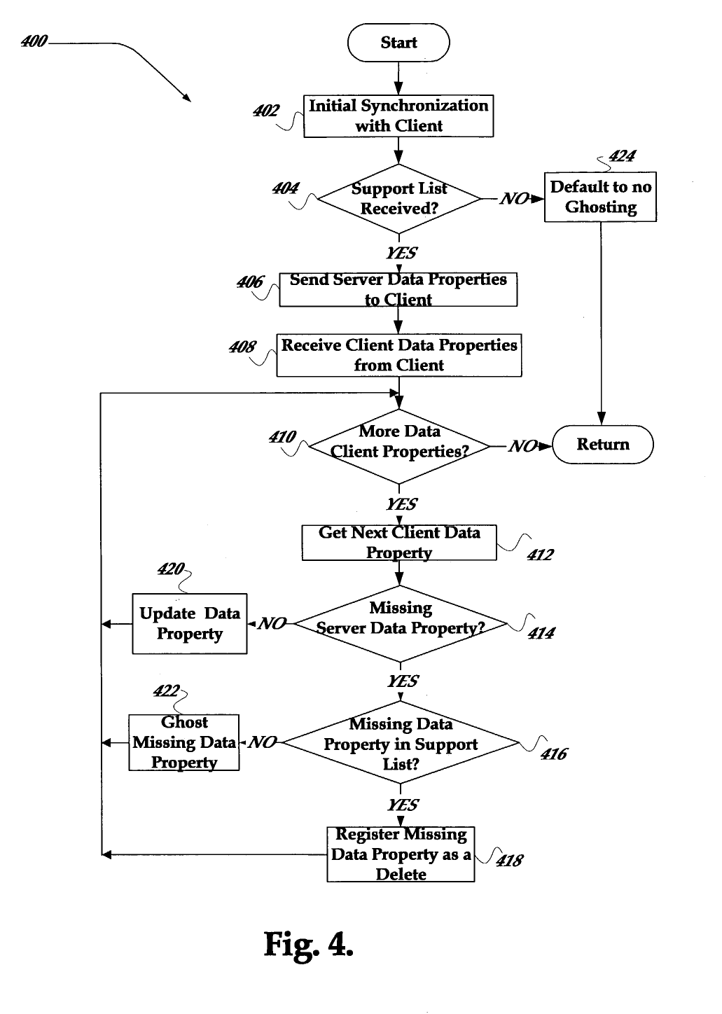

The operation of certain aspects of the present invention will now be described with respect to FIG. 4. FIG. 4 is a flow diagram generally showing one embodiment for a process of maintaining data fidelity during synchronization between a server and a client, in accordance with the present invention.

Process 400 begins, after a start block, at block 402, where an initial synchronization event occurs between the client and the server. During the initial synchronization, the client may select to send a list of data properties that are supported by the client to the server. Process 400 then flows to decision block 404, where a determination is made whether the server receives a list of supported data properties.

At decision block 404, if it is determined that a list of supported data properties is not received by the server, the process moves to block 424. At block 424, the present invention defaults to a configuration without ghosting. Moreover, the server may generate a default list of supported data properties. The default list indicates that all server data properties identified for an application, and the like, are supported by the client. Upon completion of block 424, the process returns to performing other actions.

Alternatively, at decision block 404, if it is determined that a list of supported data properties is received by the server, the process continues to block 406.

At block 406, the server provides the set of server data properties to the client. In one embodiment, a one-way ghosting is employed. In one-way ghosting, during synchronization, the server does not filter the data properties, and instead provides all server-supported data properties to the client. Upon receipt of the set of data properties from the server, the client may store a subset of server-supported data properties that it supports, and discard the remaining server-supported data properties. In another embodiment, a two-way ghosting is employed. In two-way ghosting, during synchronization, the server employs the received list of support data properties to determine which data properties to send to the client. By sending only those data properties the client supports, the bandwidth and time consumed during the synchronization may be reduced.

Process 400 proceeds to block 408, where the server receives from the client synchronization data including a set of client data properties. Typically, if the client does not employ property level change tracking, the client sends up information associated with those client data properties it supports. If the server determines that the set of sent client data properties and the set of server data properties are different, the server interprets the missing server data properties as indicating information that should be deleted on the server during the synchronization. However, because the present invention is directed to maintaining data fidelity, the process continues to decision block 410.

At decision block 410, a determination is made whether there are more client data properties to compare to the server data properties. If it is determined that there are no more client data properties to compare to the server data properties, the process returns to performing other actions. Alternatively, if it is determined that there are more client data properties to compare to the server data properties, the process proceeds to block 412, where the next client data property is obtained from the received set of client data properties. The process continues to decision block 414.

At decision block 414, a determination is made whether the set of data properties is missing a sent server data property. If it is determined that a server data property is not missing from the received set of client data properties, process flows to block 420 where the server updates information on the server associated with the received client data property. Process 400 returns to decision block 410, to continue the looping until no more client data properties exist, upon which process 400 then returns to performing other actions.

Alternatively, at decision block 414, if it is determined that a server data property is missing from the received set of client data properties, process continues to decision block 416. At decision block 416, a determination is made whether the server data property missing from the received set of client data properties is included in the support list received from the client in block 402 above. If it is determined that the missing server data property is included in the support list, the process continues to block 418, where the server registers the missing server data property as deleted. Process 400 returns to decision block 410, to continue the looping until no more client data properties exist, upon which process 400 then returns to performing other actions.

Alternatively, at decision block 416, if it is determined that the missing server data property is not included in the support list, the process proceeds to block 422, where the missing server data property is ghosted. That is, the missing server data property is left unchanged on the server, thereby maintaining data fidelity. The process returns to decision block 410, to continue the looping until no more client data properties exist, upon which process 400 then returns to performing other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A computer-readable medium having computer-executable instructions for maintaining data fidelity during synchronization, comprising:
determining a supported property associated with a client;
sending a first set of properties to the client during a synchronization;
in response to sending the first set of properties, receiving a second set of properties; and
if the first set of properties differs from the second set of properties by a property, and the property is associated with the supported property, deleting the property.

2. The computer-readable medium of claim 1, further comprising if the first set of properties differs from the second set of properties by the property, and the property is unassociated with the supported property, leaving the property unchanged.

3. The computer-readable medium of claim 1, wherein determining the supported property further comprises receiving a list of supported properties from the client.

4. The computer-readable medium of claim 1, wherein sending the first set of properties to the client further comprises sending at least one unsupported client property in the first set of properties.

5. The computer-readable medium of claim 1, wherein the first set of properties further consists of properties selected from a list of client supported properties.

6. The computer-readable medium of claim 1, wherein the property further comprises at least one of an attribute associated with an application, and an attribute associated with a hardware device.

7. The method of claim 6, wherein in application further comprises at least one of an email program, contact program, calendar program, and scheduler.

8. The method of claim 1, further comprising if the second set of properties and the first set of properties include the property, updating the property.

9. A computer-readable medium having computer-executable components for maintaining data fidelity during synchronization, comprising:
a data store that includes at least one data property;
a ghost synchronizer coupled to the data store, and configured to perform actions, including:
receiving a request to synchronize at least one data property with a client;
determining a supported property associated with the client;
sending a first set of properties to the client during the synchronization;
in response to sending the first set of properties, receiving a second set of properties from the client; and
if the first set of properties differs from the second set of properties by a property, and the property is the supported property, deleting the property.

10. The computer-readable medium of claim 9, further comprising if the first set of properties differs from the second set of properties by the property, and the property is an unsupported property, leaving the property unchanged.

11. The computer-readable medium of claim 9, further comprising if the second set of properties and the first set of properties include the property, updating the property.

12. The computer-readable medium of claim 9, wherein determining the supported property further comprises receiving a list of supported properties from the client.

13. The computer-readable medium of claim 9, wherein sending the first set of properties to the client further comprises sending at least one unsupported client property in the first set of properties.

14. The computer-readable medium of claim 9, wherein the first set of properties further consists of properties selected from a list of client supported properties.

15. The computer-readable medium of claim 9, wherein the property further comprises at least one of an attribute associated with an application, and an attribute associated with a hardware device.

16. The computer-readable medium of claim 15, wherein in application further comprises at least one of an email program, contact program, calendar program, and scheduler.

17. The computer-readable medium of claim 9, wherein the ghost synchronizer resides on a server.

18. An apparatus for maintaining data fidelity during synchronization, comprising:
(a) a transceiver for sending a first set properties to a client and receiving a second set of properties from the client; and
(b) a transcoder that is configured to perform actions, including:
(i) receiving information identifying a supported property associated with the client;
(ii) sending the first set of properties to the client during a synchronization;
(iii) receiving in response, the second set of properties from the client; and
(iv) if the first set of properties differs from the second set of properties by a property, and the property is identified as a supported property, deleting the property.

19. The apparatus of claim 18, wherein the transcoder is configured to perform further actions, including, if the first set of properties differs from the second set of properties by the property, and the property is identified as an unsupported property, leaving the property unchanged.

20. The apparatus of claim 18, wherein determining the supported property further comprises receiving a list of supported properties from the client.

21. The apparatus of claim 18, wherein sending a first set of properties to the client further comprises sending at least one unsupported client property in the first set of properties.

22. The apparatus of claim 18, wherein the first set of properties further comprises properties selected from a list of client supported properties.

23. The apparatus of claim 18, wherein the property further comprises at least one of an attribute associated with an application, and an attribute associated with a hardware device.

24. The apparatus of claim 23, wherein in application further comprises at least one of an email program, contact program, calendar program, and scheduler.

25. The apparatus of claim 18, wherein the apparatus is arranged to operate as a server.

26. The apparatus of claim 18, further comprising if the second set of properties and the first set of properties include the property, updating the property.

27. An apparatus for maintaining data fidelity during synchronization, comprising:
a means for storing at least one data property;
a means for receiving a request from a client to synchronize at least one data property;
a means for determining a set of properties supported by the client;
a means for sending a first set of properties to the client during the synchronization;
a means for receiving in response, a second set of properties;
a means for deleting the property, if the first set of properties differs from the second set of properties by the property, and the property is associated with at least one property in the set of supported properties; and
a means for leaving the property unchanged, if the first set of properties differs from the second set of properties by the property, and the property is unassociated with at least one property in the set of supported properties.
